(19) United States
(12) Patent Application Publication
(10) Pub. No.: US 2013/0027400 A1
(43) Pub. Date: Jan. 31, 2013

(54) DISPLAY DEVICE AND METHOD OF DRIVING THE SAME

(71) Applicants: Bo-Ram Kim, Seoul (KR); Jong-Yoon Lee, Ansan-si (KR); Yun-Jae Kim, Seoul (KR); Nam-Hee Goo, Asan-si (KR); Seung Hwan Moon, Asan-si (KR); Byoung Jun Lee, Yongin-si (KR); Young-Su Han, Namdong-gu (KR)

(72) Inventors: Bo-Ram Kim, Seoul (KR); Jong-Yoon Lee, Ansan-si (KR); Yun-Jae Kim, Seoul (KR); Nam-Hee Goo, Asan-si (KR); Seung Hwan Moon, Asan-si (KR); Byoung Jun Lee, Yongin-si (KR); Young-Su Han, Namdong-gu (KR)

(21) Appl. No.: 13/331,376

(22) Filed: Dec. 20, 2011

(30) Foreign Application Priority Data
Jul. 27, 2011 (KR) 10-2011-0074658

(51) Int. Cl. G06T 15/50

(52) U.S. Cl. 345/426

(57) ABSTRACT

A display device including a display panel displaying an original image at a first time and a converted image based on the original image at a second time. The average value of the luminance of a first pixel (of the original image) first time and the luminance of the first pixel (of the converted image) at the second time is substantially the same as the average value of luminance of a second pixel (of the original image) at the first time and the luminance of the second pixel (of the converted image) at the second time.

### CROSS-REFERENCE TO RELATED APPLICATION

This application claims priority to and the benefit of Korean Patent Application No. 10-2011-0074658 filed in the Korean Intellectual Property Office on Jul. 27, 2011, the entire contents of which are incorporated by reference herein.

### BACKGROUND OF THE INVENTIVE CONCEPT

1. Field of the Invention

A display device and a method of driving the same are provided.

2. Description of the Related Art

In general, in a 3D image display technology, stereoscopic perception of an object is represented by using a binocular parallax as the largest factor for recognizing the stereoscopic perception in a near distance. When different 2D images are reflected in a left eye and a right eye, respectively, and the image reflected in the left eye (hereinafter, referred to as a “left eye image”) and the image reflected in the right eye (hereinafter, referred to as a “right eye image”) are transferred to the brain, the left eye image and the right eye image are combined in the brain to be recognized as the 3D image having a perceived depth.

A three dimensional image display device uses the binocular parallax and includes a stereoscopic method using glasses such as shutter glasses, polarized glasses, or the like and an autostereoscopic method in which a lenticular lens and a parallax barrier, or the like are disposed in a display device without using glasses.

In the shutter glasses type, the left eye image and the right eye image are divided to be alternately displayed in the three dimensional image display device and a left eye shutter and a right eye shutter of the shutter glasses are selectively opened and closed, thereby expressing the 3D image.

The above information disclosed in this Background section is only for enhancement of understanding of the background of the inventive concept and therefore it may contain information that does not form the prior art that is already known in this country to a person of ordinary skill in the art.

### SUMMARY

An exemplary embodiment of the inventive concept provides a display device including a display panel configured to display an original image at a first time and a converted image based on the original image at a second time (e.g., the next instant) The average value of the luminance of a first pixel of the original image (at the first time) and the luminance of the first pixel of the converted image (at the second time) is substantially the same as the average value of the luminance of a second pixel of the original image (at the first time) and the luminance of the second pixel of the converted image (at the second time).

Luminances of all the pixels in a merged image viewed when the eyes and/or brain of the viewer merges the original image and the converted image may be substantially the same as each other.

The display device may generate a shutter control signal controlling a left eye shutter and a right eye shutter. The shutter control signal may open at least one of the left eye shutter and the right eye shutter at the first time while the original image is displayed. The shutter control signal may close both the left eye shutter and the right eye shutter at the second time when the converted image is displayed.

The display device may be synchronized to a shutter member including the left eye shutter and the right eye shutter based on security information including an identification code or a password.

The gray values of the converted image may be determined based on transformation and inverse transformation of tristimulus values for the gray value.

The gray values of the converted image may be determined based on normalization, linearization, de-linearization, and inverse normalization.

The converted image may be displayed based on a security control signal activating a security mode.

When the security control signal is 1, the gray values of the converted image may be determined based on a security mode look-up table and when the security control signal is 0, the gray values of the original image may be modified based on a normal mode look-up table.

The display device may further include a frame memory storing the original image. When the security control signal is 1, the original image may be converted into the converted image frame by frame by using the frame memory and when the security control signal is 0, the gray values of the original image may be modified based on a normal mode look-up table.

The display device may further include a graphic processor converting the original image into the converted image. When the security control signal is 1, the converted image may be generated by the graphic processor and when the security control signal is 0, the original image may be modified by the graphic processor.

The converted image may be processed into a mosaic by adding a random noise block by a block.

The original image may be horizontally or vertically interlaced by using black or white and the converted image may be horizontally or vertically interlaced by using white or black.

The gray values of the original image may be clipped into a predetermined clipped gray range.

Another exemplary embodiment of the inventive concept provides a driving method of a display device, including displaying an original image at a first time and a converted image based on the original image at a second time The average value of luminance of a first pixel of the original image and the luminance of the first pixel of the converted image is substantially the same as the average value of luminance of a second pixel of the original image and the luminance of the second pixel of the converted image.

The driving method may further include processing the converted image in mosaic by adding a random noise to the converted image block by block.

The driving method may further include interlacing the original image horizontally or vertically by using black or white and interlacing the converted image horizontally or vertically by using white or black.

The driving method may further include clipping the original image into a predetermined clipped gray range.

The inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the inventive concept. The drawings and description are to be regarded as illustrative in nature and not restrictive. Like reference numerals designate like elements throughout the specification. Further, a detailed description of the related art that has been widely known is omitted.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” or “connected” to another element, it may be directly on or connected the other element or intervening elements may also be present. In contrast, when an element is referred to as being “directly on” another element, there are no intervening elements present.

### BRIEF DESCRIPTION OF THE DRAWINGS

FIG. 1 is a schematic diagram illustrating an operation of a display device according to an exemplary embodiment of the inventive concept;

FIG. 2 is a block diagram of a display device according to an exemplary embodiment of the inventive concept;

FIG. 3 is a schematic diagram of an image conversion process according to an exemplary embodiment of the inventive concept;

FIG. 4 is a block diagram of a display device circuit according to an exemplary embodiment of the inventive concept;

FIG. 5 is a block diagram illustrating a display device circuit according to an exemplary embodiment of the inventive concept;

FIG. 6 is a block diagram of a display device according to an exemplary embodiment of the inventive concept;

FIGS. 7A to 7C are an original image, a converted image based on the original image, and a merged image displayed on a display device;

FIGS. 8A to 8C are images displayed on a display device;

FIG. 9 is a block diagram of a display device according to an exemplary embodiment of the inventive concept;

FIGS. 10A to 10C are images displayed on a display device;

FIG. 11 is a diagram illustrating an image displayed on a display device; and

FIGS. 12A to 12C are images displayed on a display device.

### DETAILED DESCRIPTION OF THE EXEMPLARY EMBODIMENTS

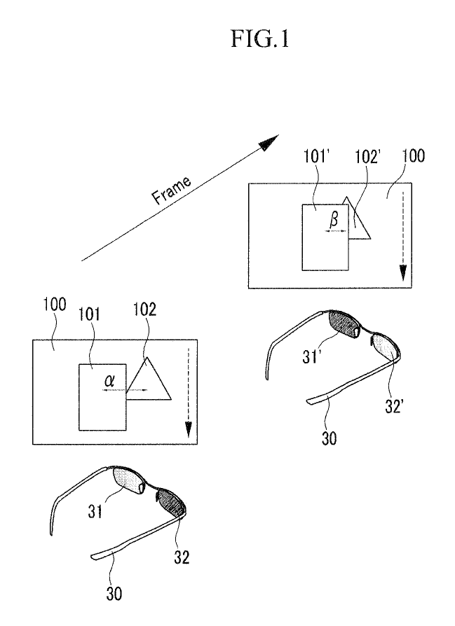

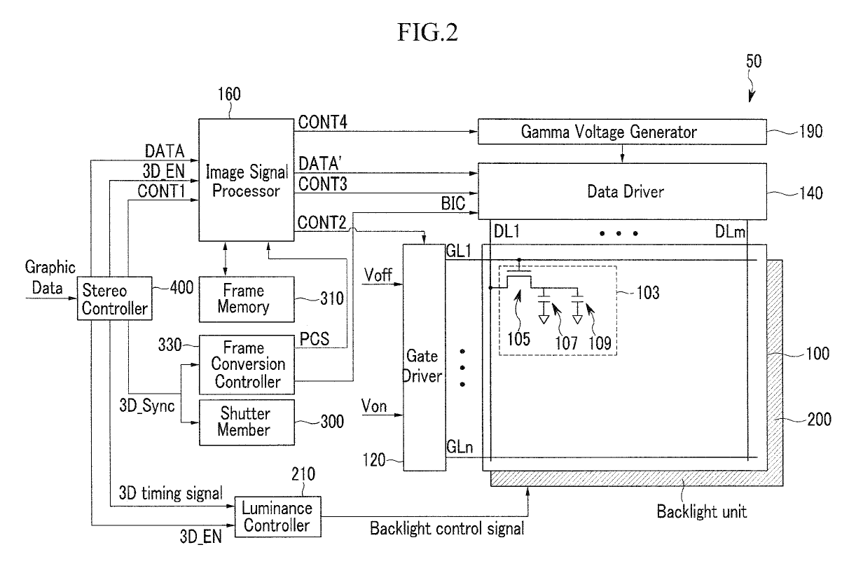

FIG. 1 is a schematic diagram illustrating an operation of a display device according to an exemplary embodiment of the inventive concept and FIG. 2 is a block diagram of a display device according to an exemplary embodiment of the inventive concept.

A display panel 100 in the display device may be implemented as a liquid crystal display (LCD), an organic light emitting diode display, a plasma display device, an electrophoretic display, an SED, or the like. Hereinafter, it is assumed that the display panel 100 is the liquid crystal display.

The LCD display panel 100 includes an upper substrate, a lower substrate, and a liquid crystal layer between the upper substrate and the lower substrate. The alignment direction of the liquid crystal molecules in the liquid crystal layer is changed by an electric field generated between two electrodes. The amount of light transmitted through the liquid crystal layer depends upon the alignment direction of the liquid crystal molecules such that the display panel 100 displays images by controlling the transmission amount of light.

The lower substrate includes gate lines GL1 to GLn, data lines DL1 to DLm, a plurality of pixels disposed at the intersections of the gate lines and data lines. A pixel includes a liquid crystal capacitor, a pixel electrode of the liquid crystal capacitor, and a thin film transistor 105 connected thereto. The thin film transistor 105 controls voltages applied to the pixel electrode based on a signal applied to the gate lines GL1 to GLn and the data lines DL1 to DLm. The pixel electrode may be a transflective pixel electrode having a transmissive region and a reflective region. A pixel may further include a storage capacitance capacitor 107 and the storage capacitance capacitor 107 maintains the voltage applied to the pixel electrode for a predetermined time. For example, one pixel 103 may include the thin film transistor 105, the storage capacitance capacitor 107, and a liquid crystal capacitance capacitor 109.

The upper substrate facing the lower substrate may include a black matrix, a color filter, and a common electrode. In alternative implementations, at least one of the black matrix, the color filter, and the common electrode formed in the upper substrate may be disposed on the lower substrate. When both the common electrode and the pixel electrode are disposed on the lower substrate, at least one of the common electrode and the pixel electrode may be formed in linear electrode form.

The liquid crystal layer may include a twisted nematic (TN) mode liquid crystal, a vertically aligned (VA) mode liquid crystal, and an electrically controlled birefringence (ECB) mode liquid crystal, or the like.

A polarizer is attached to at least one of the outer surface of the upper substrate and the outer surface of the lower substrate. Further, a compensation film is further formed between the substrate and the polarizer.

A backlight unit 200 includes at least one light source and an example of the light source is a fluorescent lamp such as a cold cathode fluorescent lamp (CCFL), an LED, or the like. In addition, the backlight unit 200 may further include a reflector, a light guide, a luminance improving film, and the like.

Referring to FIG. 2, a display apparatus 50 may include a display panel 100, a backlight unit 200, a data driver 140, a gate driver 120, an image signal processor 160, a gamma voltage generator 190, a luminance controller 210, a shutter member 300, a frame memory 310, a frame conversion controller 330, a stereo controller 400, and the like. The stereo controller 400 transmits a 3D timing signal and a 3D enable signal 3D_En to the luminance controller 210. The luminance controller 210 transmits a backlight control signal to the backlight unit 200. The backlight unit 200 may be turned ON or OFF by the backlight control signal through the luminance controller 210 and the stereo controller 400. When the duty ratio of the backlight control signal is large, the backlight unit will be brightly turned ON and when the duty ratio of the backlight control signal is small, the backlight unit will be darkly turned ON. The duty ratio is a ratio of the high level duration of the backlight control signal to the whole period of one cycle. The backlight control signal transmitted to the backlight unit 200 may turn ON the backlight unit 200 for a predetermined time. For example, the backlight control signal transmitted to the backlight unit 200 may turn ON the backlight unit 200 for a vertical blank (VB) or for the rest time other than the vertical blank.

The stereo controller 400 transmits a 3D sync signal 3D_sync to the shutter member 300 and to the frame conversion controller 330. The shutter member 300 may be electrically connected with the stereo controller 400. The shutter member 300 may receive the 3D sync signal 3D_sync by a wireless infrared communication. The shutter member 300 may be operated in response to the 3D sync signal 3D_sync or a modified 3D sync signal. The 3D sync signal 3D_sync may include all signals capable of opening or closing a left eye shutter or a right eye shutter. The frame conversion controller 330 transmits control signals PCS and BIC to the image signal processor 160 and the data driver.

The stereo controller 400 transmits a display data DATA, a 3D enable signal 3D_En, and control signals CONT1 to the image signal processor 160. The image signal processor 160 transmits various kinds of display data DATA′ and various kinds of control signals CONT2, CONT3, and CONT4 to the display panel 100 through the gate driver 120, the data driver 140, and the gamma voltage generator 190 in order to display images on the display panel 100. The display data DATA in the display device may include left eye image data, and right eye image data.

The stereo controller 400, the image signal processor 160, or the luminance controller 210 may perform a spatial filter and a temporal filter.

Referring to FIG. 1, the shutter member 300 may be stereoscopic shutter glasses 30, but is not particularly limited thereto and may include mechanical shutter glasses (goggle), optical shutter glasses, or the like. The shutter glasses 30 are formed so that right eye shutter 32 (and 32′) and left eye shutter 31 (and 31′) block the light in a predetermined cycle by synchronizing with the display panel 100. The right eye shutter may be in a CLOSED state 32 or in an OPEN state 32′ and the left eye shutter may be an OPEN state 31 or a CLOSED state 31′. For example, while the right eye shutter is OPEN, the left eye shutter may be CLOSED and on the other hand, while the left eye shutter is OPEN, the right eye shutter may be CLOSED. Further, both the left eye shutter and the right eye shutter may be OPEN or CLOSED at the same time.

The shutters of the shutter glasses 30 may be implemented by a technology such as a liquid crystal display, an organic light emitting diode display, an electrophoretic display, and the like, but is not particularly limited thereto. For example, the shutter may include two transparent conductive layers and a liquid crystal layer disposed therebetween. A polarization film may be disposed on the surface of the conductive layer. The molecules of the liquid crystal material are rotated by the voltage applied between the two transparent conductive layers and the shutter may be OPEN or CLOSED by the rotation of the liquid crystal material.

For example, while left eye images 101 and 102 are displayed on the display panel 100, the left eye shutter 31 of the shutter glasses 30 is OPEN so as to transmit the light, and the right eye shutter 32 is CLOSED so as to block the light. At a different time, while the right eye images 101′ and 102′ are displayed on the display panel 100, the right eye shutter 32′ of the shutter glasses 30 is OPEN so as to transmit the light, and the left eye shutter 31′ is CLOSED so as to block the light. Accordingly, the left eye image is viewed by only the left eye for a predetermined time and thereafter, the right eye image is viewed by only the right eye for a predetermined time, such that 3D images having depth perception are recognized by a difference between the left eye image and the right eye image.

The exemplary image viewed by the left eye includes a rectangle 101 and a triangle 102 spaced apart from each other by a distance of a. The image viewed by the right eye includes a rectangle 101′ and a triangle 102′ spaced apart from each other by a distance of β . Herein, α and β have different values and as a result, the perceived distance between the triangle to the rectangle may be different for each eye and the depth of the triangle disposed behind the rectangle may be perceived. By controlling the distances α and β between the triangle and the rectangle, the perceived distance that the triangle and the rectangle are separated from each other (and depth perception) may be controlled.

An image having a predetermined gray value may be displayed as the left eye images 101 and 102 and the right eye images 101′ and 102′. For example, a black image, a white image, a gray image, or the like may be displayed. When the image having a predetermined gray value is inserted on the overall screen of the display device, a crosstalk effect between the left eye images 101 and 102 and the right eye images 101′ and 102′ may be reduced.

Referring to FIG. 1, an arrow direction shown in the display panel 100 represents the time order of frames. The dotted arrows, substantially extending in a column direction represent the time order in which gate-on voltage is applied to the plurality of gate lines. In other words, gate-on signals may be applied from an upper gate line (row) of the display panel 100 to a lower gate line (row) in sequence.

For example, the display panel 100 may display the left eye images 101 and 102 as described below. The gate-on voltage is applied to the gate line and the data voltage is applied to the pixel electrode through the thin film transistor connected to the corresponding gate line. The applied data voltage is a data voltage (hereinafter, referred to as “left eye data voltage”) for expressing the left eye images 101 and 102 and the applied left eye data voltage is maintained for a predetermined time after the gate-off voltage is applied to the gate line by the storage capacitance capacitor. Similarly, data voltage (hereinafter, referred to as “right eye data voltage”) for expressing the right eye images 101′ and 102′ is applied to the pixel electrode and the applied right eye data voltage may be maintained for a predetermined time by the storage capacitance capacitor.

When images having two colors in a complementary color relationship are displayed on the display device sequentially for a very short time, it may be difficult for a user without the shutter member to recognize the images having two colors as an image having a single color. The complementary color relationship means that two colors overlap each other to make white. For example, when one color is data 8bits and the two colors are in the complementary color relationship if the sum of gray values of two colors is 255. For example, a color having a gray value of 0 and a color having a gray value of 255 are in the complementary color relationship. And, for another example, a color having a gray value of 192 and a color having a gray value of 63 are in the complementary color relationship.

When an original image is inputted and the original image and a converted image having a complementary color relationship with the original image are alternately displayed on the display device for a very short time, it may be difficult for a user without the shutter member to recognize the original image and the converted image as an image having a single color.

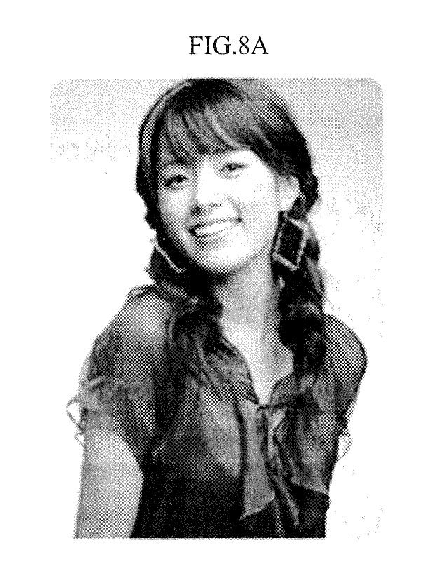

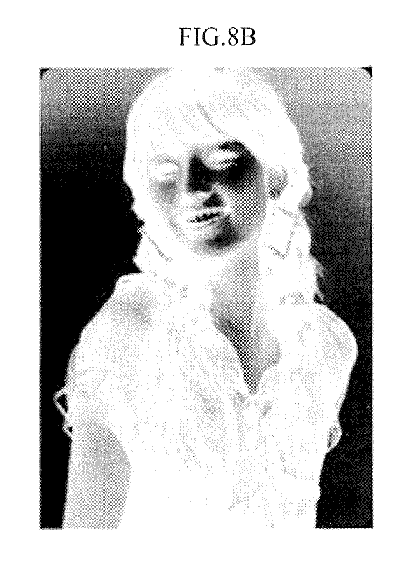

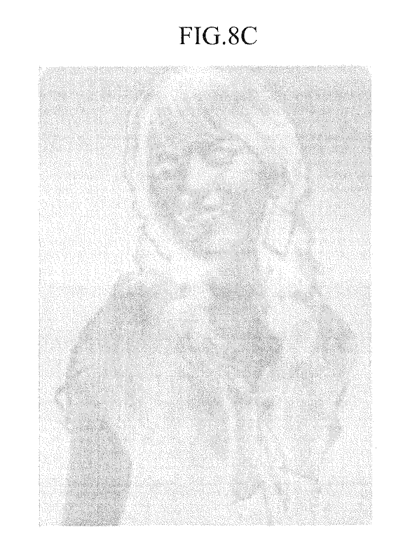

FIGS. 8A to 8C are images displayed on a display device.

For example, referring to FIGS. 8A to 8C, when the converted image of FIG. 8B is just in the complementary color relationship with the original image of FIG. 8A, the image of FIG. 8C in which an object is blurredly displayed may be recognized by the user without the shutter member because the sum of luminance in the original image and luminance in the converted image have different values for each pixel. For example, when R, G, and B of one pixel have gray values of 192, 192, and 192 in the original image, luminance of the corresponding pixel is about 53% and when R, G, and B of one pixel have gray values of 63, 63, and 63 in the converted image in the complementary color relationship, luminance of the corresponding pixel is about 5%, such that average luminance is about 29%. When R, G, and B of one pixel have gray values of 255, 255, and 255 in the original image, luminance of the corresponding pixel is about 100% and when R, G, and B of one pixel have gray values of 0, 0, and 0 in the converted image in the complementary color relationship, luminance of the corresponding pixel is about 0%, such that average luminance is about 50%. In each pixel, the averages of the gray values have the same value of 127, but the averages in luminance have different values of 29% and 50%, such that the object may be blurredly displayed. A phenomenon occurs in which the boundary of the object visible in the original image of FIG. 8A is shown in the merged image of FIG. 8C recognized by the user without the shutter member largely occurs in a low gray near to black and in a high gray near to white.

Accordingly, the gray values of the converted image are determined so that the luminance averages in the original image and the converted image are substantially the same as each other, such that the original image and the converted image may be recognized as one image without appearing as a blurred object to the user without the shutter member and a security function and a privacy protection function of the display device may be improved. The original image and the converted image which are viewed by a user without the shutter member are called a merged image. Luminances of all pixels in the merged image may be all the same as each other. The original image may be a password input screen requiring the security such as a safe and the like. The merged image is a different image from the original image and an image in which it is difficult for the user without the shutter member to guess the original image from. For example, the merged image may be an image with a geometric pattern, or text.

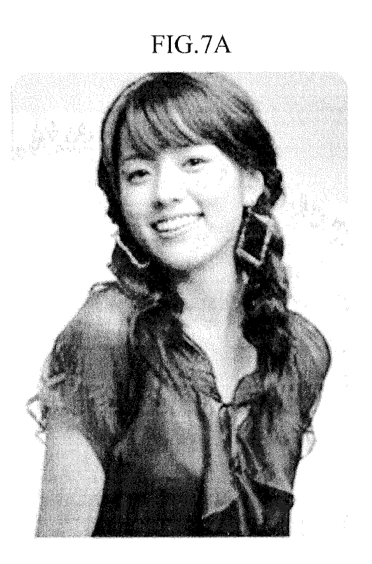

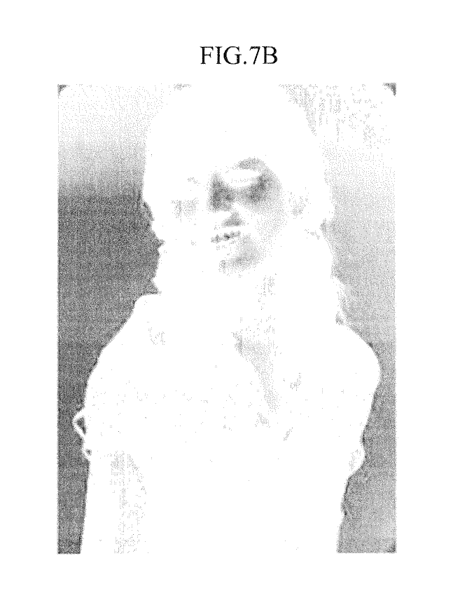

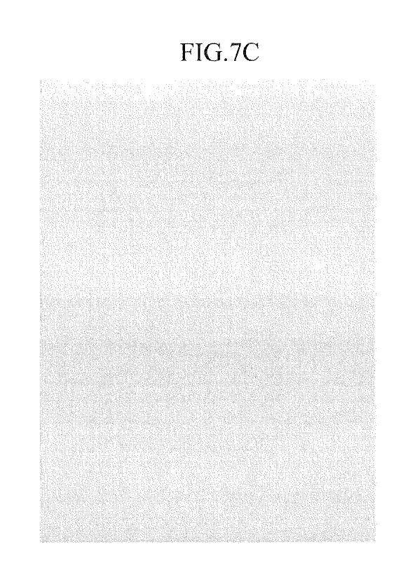

FIGS. 7A to 7C are an original image, a converted image based on the original image, and a merged image displayed on a display device.

For example, referring to FIGS. 7A to 7C, when the original image of FIG. 7A and the converted image of FIG. 7B are alternately displayed on the display device for a short time, the merged signal-color image of FIG. 7C is recognized by the user without the shutter member. The frequencies of the original image and the converted image may be, for example, 60 Hz or more. The left eye shutter and the right eye shutter of the shutter member are synchronized and OPEN for the time when the original image is displayed and the left eye shutter and the right eye shutter of the shutter member are synchronized and CLOSED for the time when the converted image is displayed. Thus, the user with the shutter member recognizes only the original image and does not recognize the converted image. Only a specific shutter member may be synchronized on the display device and in this case, security information such as an identification code, a password, and the like may be used.

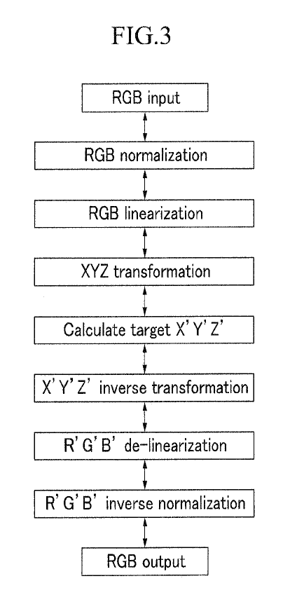

The gray values of the converted image may be determined by the image conversion process of FIG. 3 so that the luminance averages of all pixels in the original image and the converted image are substantially the same as each other. For example, the gray values of the converted image may be determined based on transformation and inverse transformation of tristimulus values for the gray value.

If the gray values of the original image are inputted, data of the original image is normalized by the following Equation 1.

$${R}^{′} = \frac{{R}_{N}}{255} \qquad [ Equation 1 ]$$

In the Equation 1, RN is a gray value of the original image.

The normalized image is linearized by the following Equation 2.

$$R = \{ \begin{matrix}{R}^{′} / 12.92 & R \leq 0.04045 \\ {[ ( {R}^{′} + 0.055 ) / 1.055 ]}^{2.4} & R > 0.04045\end{matrix} \qquad [ Equation 2 ]$$

In the Equation 2, R′ is data of the normalized image.

The linearized image is transformed by the following Equation 3 to calculate the tristimulus values.

$$[ \begin{matrix}X \\ Y \\ Z\end{matrix} ] = [ \begin{matrix}0.412 & 0.358 & 0.180 \\ 0.213 & 0.715 & 0.072 \\ 0.019 & 0.119 & 0.950\end{matrix} ] \cdot {[ \begin{matrix}R \\ G \\ B\end{matrix} ]}_{6 , 500 K} \qquad [ Equation 3 ]$$

In the Equation 3, R, G, and B are data of the linearized image and a color temperature is 6500 K.

The tristimulus values of the original image are transformed by the following Equation 4 to calculate the tristimulus values of the converted image.

$$[ \begin{matrix}{X}^{′} \\ {Y}^{′} \\ {Z}^{′}\end{matrix} ] = [ \begin{matrix}{X}_{0} \\ {Y}_{0} \\ {Z}_{0}\end{matrix} ] - [ \begin{matrix}X \\ Y \\ Z\end{matrix} ] \qquad [ Equation 4 ]$$

In the Equation 4, X₀, Y₀, and Z₀ are target tristiumlus values and tristiumlus values for a single-color image recognized by the user without the shutter member.

The tristiumlus values of the converted image are calculated as gray values of the converted image by inverse transformation of the following Equation 5, de-linearization of the following Equation 6, and inverse normalization of the following Equation 7.

$$\begin{matrix}[ \begin{matrix}{R}^{′} \\ {G}^{′} \\ {B}^{′}\end{matrix} ] = [ \begin{matrix}3.248 & - 1.543 & - 0.499 \\ - 0.973 & 1.879 & 0.042 \\ 0.057 & - 0.205 & 1.057\end{matrix} ] \cdot [ \begin{matrix}{X}^{′} \\ {Y}^{′} \\ {Z}^{′}\end{matrix} ] & [ Equation 5 ] \\ {R}_{l} = \{ \begin{matrix}{R}^{′} \times 12.92 \\ ( {{R}^{′}}^{1 / 2.4} \times 1.055 ) - 0.055\end{matrix} & [ Equation 6 ] \\ {R}^{′} = {R}_{l} \times 255 & [ Equation 7 ]\end{matrix}$$

By measuring luminance corresponding to the gray values of the converted image through an experiment, the gray values of the converted image corresponding to the gray values of the original image may be determined so that the luminance averages in the original image and the converted image are substantially the same as each other. For example, a look-up table LUT like the following Table 1 may be used.

TABLE 1

| Original | Converted |
|---|---|
| Image (gray) | Image (gray) |
| 0 | 255 |
| 4 | 249 |
| 8 | 248 |
| 12 | 248 |
| 16 | 247 |
| 20 | 247 |
| 24 | 246 |
| 28 | 246 |
| 32 | 245 |
| 40 | 244 |
| 48 | 243 |
| 56 | 242 |
| 64 | 240 |
| 72 | 239 |
| 80 | 237 |
| 88 | 235 |
| 96 | 233 |
| 104 | 232 |
| 112 | 230 |
| 120 | 228 |
| 128 | 226 |
| 136 | 222 |
| 144 | 215 |
| 152 | 208 |
| 160 | 201 |
| 168 | 193 |
| 176 | 185 |
| 184 | 177 |
| 192 | 169 |
| 200 | 161 |
| 208 | 152 |
| 216 | 143 |
| 224 | 133 |
| 232 | 103 |
| 240 | 65 |
| 248 | 11 |
| 255 | 0 |

Look-up tables for red, green and blue may be the same as each other. The gray values which are not included in the look-up table may be calculated by a method such as an interpolation and the like. For example, when the gray values of R of the original image is 161, the gray value of G thereof is 156, and the gray value of B thereof is 75, the gray value of R of the converted image may be 201, the gray value of G thereof may be 208, and the gray value of B thereof may be 239. In this case, the original image and the converted image displayed in turn by a period of 1/120 second are recognized as the single-color image by the user without the shutter member, but only the original image is recognized by the user with the shutter member because luminances of the pixels in the merged image are the same as each other.

In another example the converted image is in the complementary color relationship with the original image, the gray value of R of the converted image is 94, the gray value of G thereof is 99, and the gray value of B thereof is 180. In this case, it is difficult for the user without the shutter member to recognize the original image and the converted image which are displayed by the unit of 1/120 second in turn as a single-color image because luminances of the pixels in the merged image are not the same as each other.

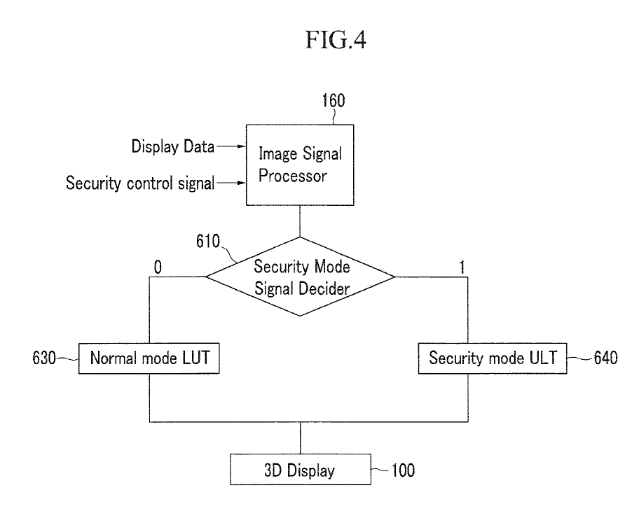

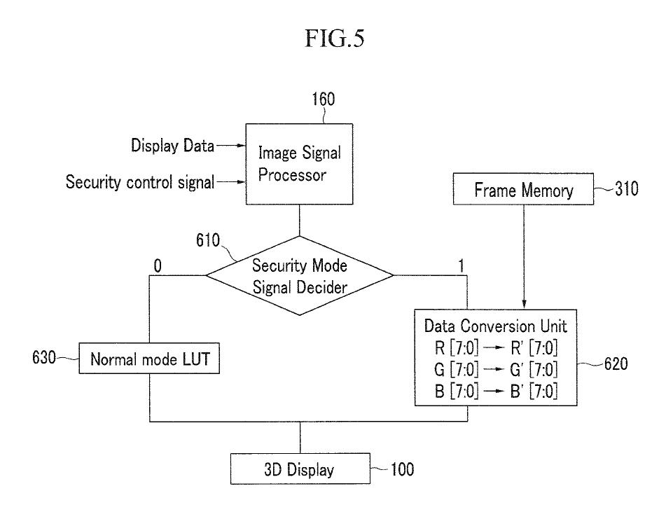

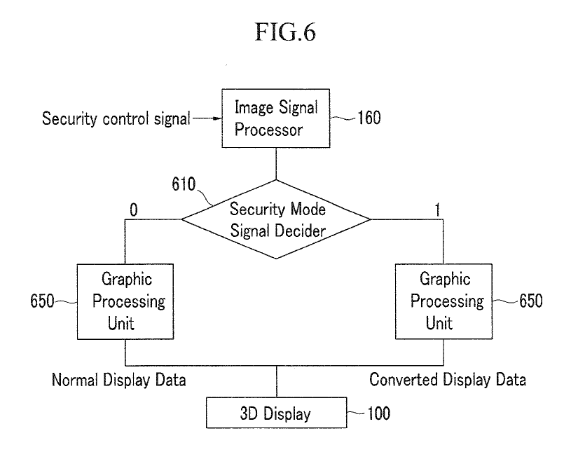

FIG. 4 is a block diagram of a display device circuit according to an exemplary embodiment of the inventive concept. FIG. 5 is a block diagram illustrating a display device circuit according to an exemplary embodiment of the inventive concept. FIG. 6 is a block diagram of a display device according to an exemplary embodiment of the inventive concept.

Referring to FIGS. 4, 5 and 6, based on a security control signal activating a security mode, images to which the security mode is applied may be displayed or images of a normal mode to which the security mode is not applied may be displayed. The security mode may be activated or inactivated by the user. For example, in the display device having driving frequency of 120 Hz, when the frame frequency of an input image is 60 Hz and the security control signal is 1, the original image and the converted image may be alternately displayed at the frame frequency of 120 Hz after generating the converted image corresponding to the original image. When a 3D image including a left eye image and a right eye image is inputted at the frame frequency of 120 Hz and the security control signal is 1, the left eye image and the right eye image may be displayed alternately at the frame frequency of 120 Hz. When a 2D image is inputted at the frame frequency of 60 Hz or 120 Hz and the security control signal is 0, the original image may be displayed by the frame frequency of 60 Hz or 120 Hz as it is without the converted image.

Referring to FIG. 4, an image signal processor 160 receives display data and the security control signal. A scaling integrated circuit instead of the image signal processor 160 may be used. A security mode signal decider 610 determines whether the security control signal is 0 or 1. When the security control signal is 0, the input image may be modified by a normal mode look-up table 630. For example, the normal mode look-up table 630 may be a look-up table for overshoot driving or undershoot driving. When the security control signal is 1, the converted image is generated by a security mode look-up table 640, such that the original image and the converted image may be alternately displayed. For example, the security mode look-up table 640 may be the above Table 1. The normal mode look-up table 630 and the security mode look-up table 640 may be stored in a memory and for example, may be stored in a non-volatile memory such as an electrically erasable programmable read-only memory (EEPROM).

Referring to FIG. 5, the image signal processor 160 receives the display data and the security control signal. A scaling integrated circuit may be used instead of the image signal processor 160. The security mode signal decider 610 determines whether the security control signal is 0 or 1. When the security control signal is 0, the input image may be modified by the normal mode look-up table 630. For example, the normal mode look-up table 630 may be a look-up table for overshoot driving or undershoot driving. When the security control signal is 1, the converted image is generated by a data conversion unit 620, such that the original image and the converted image may be alternately displayed. For example, the original image may be stored and converted by a frame unit by using an algorithm for the image conversion process of FIG. 3 and a frame memory 310.

Referring to FIG. 6, the image signal processor 160 receives the display data and the security control signal. A scaling integrated circuit may be used instead of the image signal processor 160. The security mode signal decider 610 determines whether the security control signal is 0 or 1. When the security control signal is 0, the input image may be modified by a graphic processing unit (GPU) 650. When the security control signal is 1, the converted image is generated by the graphic processing unit 650, such that the original image and the converted image may be alternately displayed. For example, the graphic processing unit 650 may directly convert the original image into the converted image by using an algorithm for the image conversion process of FIG. 3.

By adding a random noise to the converted image block by block, the converted image is processed as a mosaic and the user without the shutter member views the merged image of the converted image processed as a mosaic and the original image and it is more difficult for the user without the shutter member to guess the original image as compared with the converted image which is not processed as a mosaic. The converted image may be an image which is in the complementary color relationship with the original image and an image in which luminances of the pixels are substantially the same as each other in the merged image. For example, when the size of the block is 16×16, the random noise of a first pixel block is 4, and the random noise of a second pixel block is −7, 4 may be added to the gray values of the 256 pixels of the first pixel block in the converted image, respectively and −7 may be added to the gray values of the 256 pixels of the second pixel block in the converted image, respectively. The size and the sign of the random noise may be randomly determined.

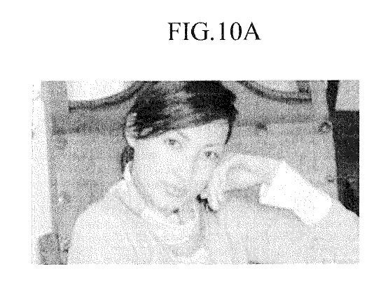

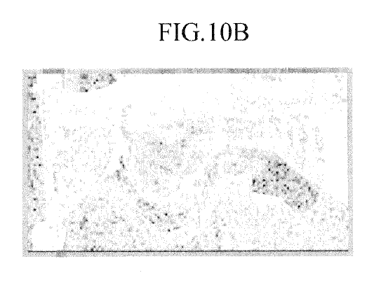

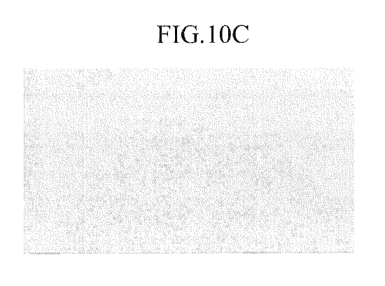

FIGS. 10A to 10C are images displayed on a display device.

For example, referring to FIGS. 10A to 10C, FIG. 10A is the original image, FIG. 10B is the converted image with the random noise added, and FIG. 10C is the merged image recognized by the user without the shutter member. The merged image of FIG. 10C is further distorted than the merged image of FIG. 7C or the merged image of FIG. 8C.

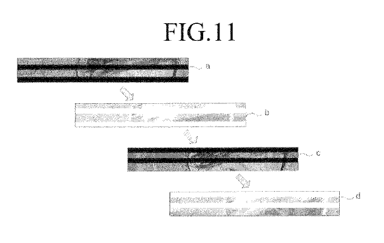

By horizontally or vertically interlacing the original image and the converted image by using black and white, it is more difficult for the user without the shutter member to guess the original image as compared with the case where the original image and the converted image are not interlaced. The converted image may be an image which is in the complementary color relationship with the original image and an image in which luminances of the pixels in the merged image are substantially the same as each other. The converted image may be processed as a mosaic by using the random noise. For example, referring to FIG. 11, four images a, b, c, and d are displayed with a time interval of 1/120 second and may be displayed with an interval faster than 1/120 second. An original image a of an odd frame and an original image c of an even frame are horizontally interlaced at different positions from each other by using black. A converted image b of an odd frame and a converted image d of an even frame are horizontally interlaced at different positions from each other by using white. Gray of the original image, gray of the converted image, black, and white are displayed in sequence in the pixels of each one horizontal line. Since the original image a of the odd frame and the original image c of the even frame are displayed in the first frame and the third frame, respectively, a flicker phenomenon generated in driving at 30 Hz may not be generated in the image of FIG. 11. Unlike as shown in the image of FIG. 11, the original image and the converted image may be vertically interlaced. Further, the original image may be horizontally or vertically interlaced by using white and the converted image may be horizontally or vertically interlaced by using black.

By clipping the original image into a predetermined gray range, (remapping the gray values of the original image into a predetermined clipped gray range) it is more difficult for the user without the shutter member to guess the original image as compared with the original image which is not clipped. Since a phenomenon in which the boundary of the object is shown in the merged image recognized by the user without the shutter member largely occurs in a low gray near to black and a high gray near to white, neither a low gray nor a high gray is displayed on the clipped original image. For example, when the gray is 0 to 255, a predetermined clipped gray range may be 100 to 192.

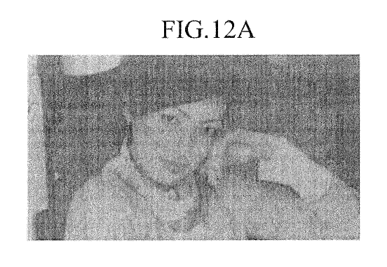

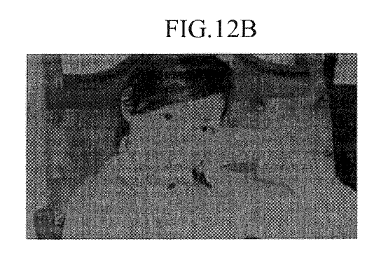

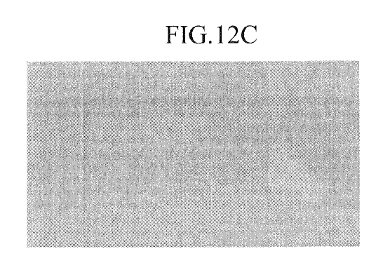

FIGS. 12A to 12C are images displayed on a display device.

Referring to FIGS. 12A to 12C, FIG. 12A is an original image clipped to within a range of 100 to 192 grays among 256 grays, FIG. 12B is an original image clipped to within 0 to 92 grays among 256 grays, and FIG. 12C is an original image clipped to within 192 to 255 grays among 256 grays. It is seen that the images of FIGS. 12B and 12C are the original image but seriously damaged. The clipped original image may be horizontally or vertically interlaced by using black or white and the converted image of the clipped original image may be horizontally or vertically interlaced by using black or white. The converted image may be an image which is in the complementary color relationship with the original image and an image in which luminances of the pixels in the merged image are substantially the same as each other. The converted image may be processed into a mosaic by using the random noise.

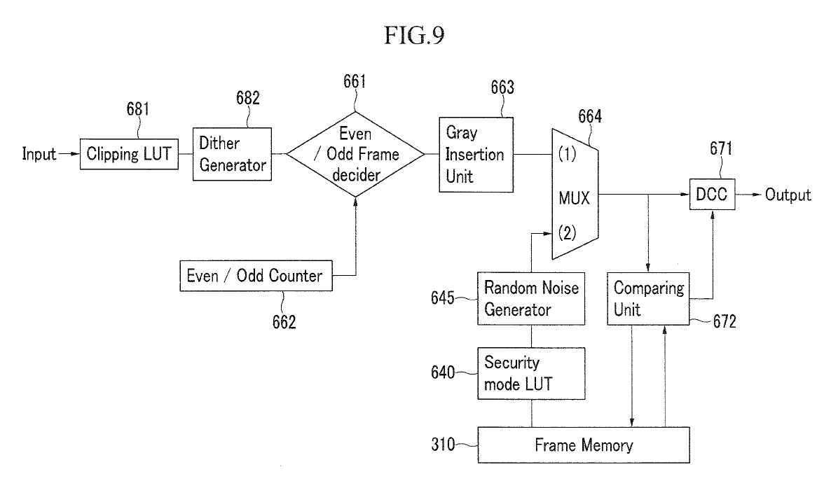

FIG. 9 is a block diagram of a display device according to an exemplary embodiment of the inventive concept.

Referring to FIG. 9, the inputted original image is clipped into a predetermined gray range (remapping the gray values of the original image into a predetermined clipped gray range) by a clipping look-up table 681. The clipped original image is dithered by a dithering generator 682. At least one of the clipping look-up table 681 and the dithering generator 682 may be omitted. An image inputted to an even/odd frame decider 661 is divided into even frame data and odd frame data using an even/odd counter 662. An image output from the even/odd frame decider 661 is inputted into a gray insertion unit 663 to be horizontally (or vertically) interlaced by using black or white. For example, in the even frame data, black may be inserted into an odd horizontal lines of the image and in the odd frame data, black may be inserted into an even horizontal lines of the image. An image output from the gray insertion unit 663 is inputted to an input terminal IN1 of a multiplexer 664 through a frame clock delay (for example at of 60 Hz).

An image stored in the frame memory 310 is converted by the security mode look-up table 640 and the converted image may be an image in which luminances of the pixels in the merged image are substantially the same as each other. An image displayed from the security mode look-up table 640 is inputted to a random noise generator 645 to be processed into a mosaic by using the random noise. An image output from the random noise generator 645 is inputted to an input terminal IN2 of the multiplexer 664 through the frame clock delay (for example at 60 Hz). The random noise generator 645 may be omitted.

The multiplexer 664 sequentially outputs two images inputted to its two input terminals IN1 and IN2 controlled by timing unit such as the even/odd counter 662. The even/odd frame decider 661, the even/odd counter 662, the gray insertion unit 663, and the multiplexer 664 may be omitted and in that case, the non-interlaced original image and the converted image are displayed.

The image output from the multiplexer 664 is modified by a dynamic capacitance compensation (DCC) 671, a comparing unit 672, and the frame memory 310. The DCC 671 corrects an image of a current frame based on images stored in the frame memory 310 such as an image of a previous frame and an image of a next frame. For example, the DCC 671 may perform the overshoot driving or the undershoot driving. The image displayed from the multiplexer 664 is compressed before being inputted to the DCC 671 to be stored in the frame memory 310 as data of the current frame and the stored image data is converted by the security mode look-up table 640 and the random noise generator 645.

According to exemplary embodiments of the inventive concept, a security function and a privacy protection function of a display device may be implemented.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A display device, comprising:
a display panel having a plurality of pixels configured to display an original image at a first time and a converted image based on the original image at a second time,
wherein the average of the luminance of a first pixel of the display panel at the first time and the luminance of the first pixel of the display panel at the second time is substantially the same as the average of luminance of a second pixel of the display panel at the first time and the luminance of the second pixel of the display panel at the second time.

2. The display device of claim 1, wherein:
luminances of pixels in a merged image viewed by merging the original image and the converted image are substantially the same as each other.

3. The display device of claim 1, wherein:
the display device generates a shutter control signal controlling a left eye shutter and a right eye shutter and the shutter control signal opens the left eye shutter at the first time and opens the right eye shutter at the second time and closes the left eye shutter at the second time and closes the right eye shutter at the first time.

4. The display device of claim 3, wherein:
the display device is synchronized to a shutter member including the left eye shutter and the right eye shutter based on security information including an identification code or a password.

5. The display device of claim 3, wherein:
the gray values of the converted image are determined based on transformation and inverse transformation of tristimulus values of the original image.

6. The display device of claim 5, wherein:
the gray values of the converted image are determined based on normalization, linearization, de-linearization, and inverse normalization.

7. The display device of claim 3, wherein:
the converted image is displayed based on a security control signal activating a security mode.

8. The display device of claim 7, wherein:
while the security control signal is 1, the gray values of the converted image are determined based on a security mode look-up table and while the security control signal is 0, the gray values of the original image are modified based on a normal mode look-up table.

9. The display device of claim 7, further comprising:
a frame memory storing the original image,
wherein while the security control signal is 1, the original image is converted into the converted image frame by frame unit by using the frame memory and while the security control signal is 0, the gray values of the original image are modified based on a normal mode look-up table.

10. The display device of claim 7, further comprising:
a graphic processing unit configured to generate the converted image based on the original image by changing the gray values of the original image,wherein while the security control signal is 1, the converted image is generated by the graphic processor and while the security control signal is 0, the gray values of the original image are modified by the graphic processor.

11. The display device of claim 3, wherein:
the converted image is produced as a mosaic by adding a random noise block by block unit.

12. The display device of claim 11, wherein:
the original image is horizontally interlaced with black and the converted image is horizontally interlaced white; or wherein
the original image is horizontally interlaced with white and the converted image is horizontally interlaced with black; or wherein
the original image is vertically interlaced with black and the converted image is vertically interlaced with white; or wherein
the original image is vertically interlaced with white and the converted image is vertically interlaced with black.

13. The display device of claim 12, wherein:
the gray values of the original image are remapped into a predetermined clipped gray range.

14. The display device of claim 3, wherein:
the original image is horizontally or vertically interlaced by using black or white and the converted image is horizontally or vertically interlaced by using white or black.

15. The display device of claim 14, wherein:
the gray values of the original image are remapped into a predetermined clipped gray range.

16. A driving method of a display device, comprising:
generating a first converted image based on an first original image by changing the gray values of the first original image;
displaying the first original image at a first time on a display panel of the display device and displaying the first converted image on the display panel at a second time,
wherein the average value of the luminance of a first pixel of the display panel at the first time and the luminance of the first pixel of the of the display panel at the second time is substantially the same as the average value of the luminance of a second pixel at the first time and the luminance of the second pixel at the second time.

17. The method of claim 16, further comprising
generating a second converted image based on a second original image by changing the gray values of the second original image;
displaying the second original image at a third time on the display panel of the display device and displaying the second converted image on the display panel at a fourth time,
wherein the average value of the luminance of the first pixel of the display panel at the third time and the luminance of the first pixel of the of the display panel at the fourth time is substantially the same as the average value of the luminance of the second pixel at the third time and the luminance of the second pixel at the fourth time.

18. The method of claim 17,
the display device generates a shutter control signal controlling a left eye shutter and a right eye shutter and the shutter control signal opens the left eye shutter at the first time and opens the right eye shutter at the second time and closes the left eye shutter at the second time and closes the right eye shutter at the second time, and
wherein the shutter control signal opens the left eye shutter at the third time and opens the right eye shutter at the fourth time and closes the left eye shutter at the fourth time and closes the right eye shutter at the third time.

19. The method of claim 18, wherein the first original image is a left eye image and the second original image is a right eye image.

20. The method of claim 16, wherein:
the display device generates a shutter control signal controlling a left eye shutter and a right eye shutter and the shutter control signal opens the left eye shutter at the first time and opens the right eye shutter at the second time and closes the left eye shutter at the second time and closes the right eye shutter at the second time.

21. The method of claim 20, further comprising:
mosaic-processing the converted image by adding a random noise to the converted image block by block.

22. The method of claim 21, further comprising:
interlacing the original image horizontally or vertically by using black or white and interlacing the converted image horizontally or vertically by using white or black.

23. The method of claim 22, further comprising:
remapping the gray values of the original image into a predetermined clipped gray range.
